(19) United States
(12) Patent Application Publication
(10) Pub. No.: US 2008/0163716 A1
(43) Pub. Date: Jul. 10, 2008

(54) Steering Column With Impact Energy Absorbing Device

(75) Inventors: Stefan Battlogg, St. Anton/Montafon (AT); Jurgen Posel, Bludenz (AT)

Correspondence Address: LERNER GREENBERG STEMER LLP, P O BOX 2480, HOLLYWOOD, FL, 33022-2480, US

(73) Assignee: INVENTUS ENGINEERING GMBH, St. Anton/Montafon (AT)

(21) Appl. No.: 11/994,269

(22) PCT Filed: Jun. 30, 2006
(86) PCT No.: PCT/AT2006/000280

§ 371 Date: Dec. 28, 2007

(30) Foreign Application Priority Data
Jun. 30, 2005 (AT) A 1109/2005

(51) Int. Cl. B62D 1/19

(52) U.S. Cl. 74/493

(57) ABSTRACT

The invention relates to a steering column provided with an impact energy absorbing element, comprising a collapsible container (1) containing a flowing medium. The medium is pressed through an opening (2) on an impact, the resistance of which can be controlled by a device (10).

The invention relates to a steering column, in particular for motor vehicles, with an impact energy absorbing element that is equipped with a container holding a flowable medium, with the medium, in the event of an impact, being forced through at least one opening whose counterforce is controllable.

Energy absorbing elements have been known in a multitude of embodiments. In recent years, elements containing an electrorheological or magnetorheological fluid that changes the viscosity under the influence of an electric or magnetic field have been used increasingly for energy absorption. Control of the counterforce exerted by the opening is of great importance since the energy absorption can be adapted to varying initial states and conditions, which means that such energy absorbing elements can be used particularly in the steering columns of motor vehicles. During a crash, several systems are being deployed one after the other or, respectively, simultaneously (seatbelt, airbag and ultimately the steering column) that are designed to slow down the driver with as little stress as possible. The seatbelt and the airbag oftentimes do not provide an ideal counterforce which is to be compensated by a controllable impact shock absorber in the steering column. The overall result thus becomes bearable for the occupant since the energy can be gently absorbed in the case of injury-critical surface pressure values and deceleration values. During this process, the individual components may follow rapidly changing courses that in sum, however, result in a gentle course of actions.

In accordance with U.S. Pat. No. 6,279,952 which shows such a steering column, the flowable medium is arranged in a cylinder-piston system and can stream out through overflow openings in the piston or in the cylinder. The overflow openings can be designed to open only when a certain excess pressure is reached in the medium.

In contrast with vibration absorbers and shock absorbers that are intended for permanent use, impact absorbers in steering columns are only provided for an emergency and are in most cases not used at all. Nevertheless, the operability of the impact absorber must be assured even after years of inactivity. In the case of cylinder-piston systems, years of inactivity may lead to problems since impermeability of the system as well as operability are critical. Seals lose their sealing properties and movable parts, their mobility.

The invention now has as its objective the creation of a steering wheel whose energy absorbing element does not contain any mechanically movable parts or seals; this is achieved through the fact that the container holding the flowable medium is deformable. In this context, it is assumed that it is irrelevant in the event of an impact that is to be absorbed, for example in the case of a traffic accident or the like, whether or not the energy absorbing element is damaged or becomes unusable.

In a preferred design, the container is equipped with a compressible container part and a non-compressible discharge channel in which the opening is located. In this way, the area surrounding the opening is not affected by the deformation, and the mechanism for controlling the counterforce can preferably envelop the discharge channel.

In an additional preferred embodiment, the compressible container part has a deformable container wall, in particular a bellows or a membrane bellows that is compressible in the axial direction of the discharge tube.

For a one-time use, the opening is preferably covered by a closing element that releases the opening when a certain excess pressure is exceeded.

As mentioned before, control of the counterforce is of great importance in order to adapt the energy absorption to varying initial states and conditions, for example to the mass and/or speed of the impacting object. The counterforce may, for example, be set or changed by enlarging or reducing the cross section of the discharge opening. Preferably, however, the compressible and/or deformable container is filled with a medium that changes its fluidity under the influence of an electric or magnetic field. Magnetorheological fluids are particularly well suited for this purpose because in contrast with electrorheological fluids, only lower, safe voltages are required for the creation or, respectively, for the changing of the field.

In the following, the invention will be described in detail by means of the attached drawing, without being limited thereto. Shown are:

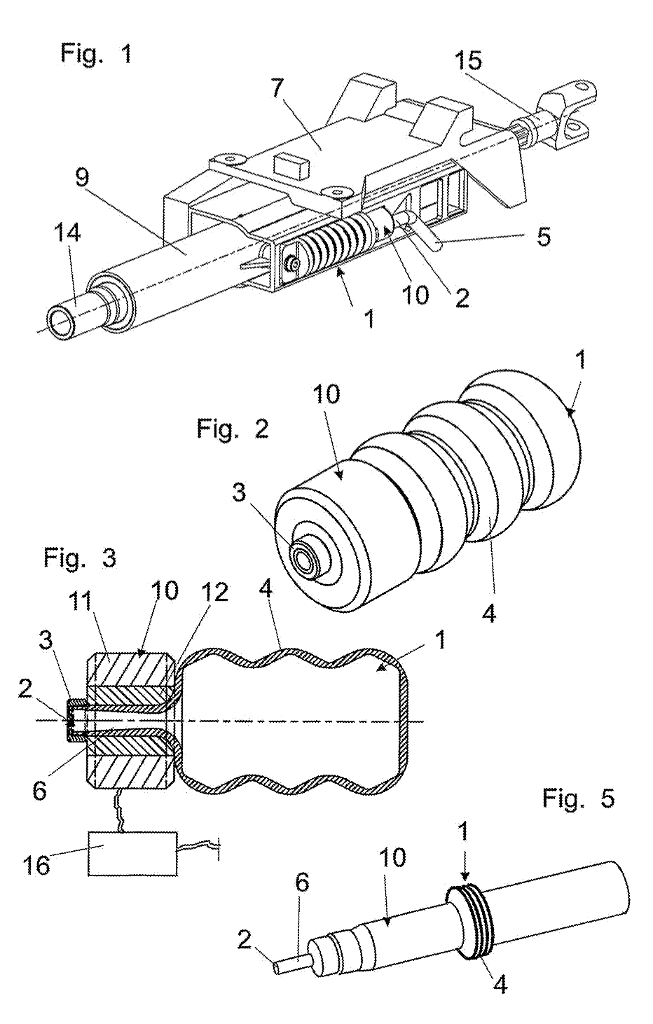

in FIG. 1 a schematic section of an original embodiment of a steering column with an impact energy absorbing element.

in FIG. 2 a slanted view, turned 180°, of the element absorbing the impact energy of FIG. 1.

in FIG. 3 a longitudinal cut through the element according to FIG. 2

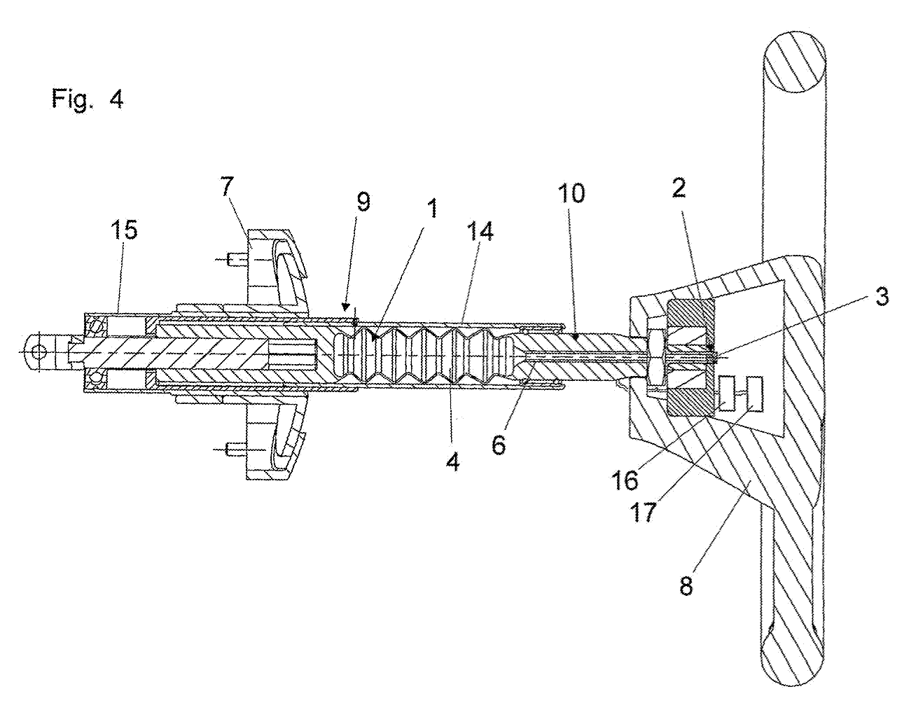

in FIG. 4 a second embodiment of a steering wheel of a motor vehicle in a longitudinal cut with an impact energy absorbing element, and

in FIG. 5 a schematic slanted view of the impact energy absorbing element according to FIG. 4 following an impact.

In an original embodiment, a steering column 9 as shown in FIG. 1 is provided with an impact energy absorbing element parallel to its parts 14, 15 that are relocatable in a longitudinal direction in the event of a collision, which means that conventional steering columns can be used unmodified and can be equipped with the element. The element is connected at one end to a relocatable part 14 of the steering column 9 while the other end that is connected to a flow-off line 5 is fixed to a non-relocatable part 15 of the steering column 9 that is supported by an element 7 permanently attached to the vehicle body.

According to FIGS. 2 and 3, the impact energy absorbing element contains a compressible container 1 that is filled with a magnetorheological fluid and that is equipped with a compressible container part 4 as well as with a non-compressible discharge channel 6 adjacent to it in axial direction of the compression, with the discharge channel having an opening 2. In the event of an impact, the steering column 9 can collapse and the fluid in the container 1 will be pressed through the opening 2 into the flow-off pipe 5 when the container is compressed. At the transition from the container to the discharge channel 6, a counterforce is created that influences the ejection criteria of the fluid to the effect that the impact energy is absorbed. For this purpose, the discharge channel 6 is surrounded by a mechanism 10 for the generation of an alterable magnetic field. The mechanism 10 comprises an electromagnet via which a magnetic field is created or the magnetic field of a permanent magnet 12 is influenced. The electromagnet can be controlled by an electronic system via signals from sensors monitoring an impact, in dependence of various criteria such as the weight and seat position of the driver; buckled up or not buckled up; airbag switched on or switched off, etc., with the alterable magnetic field changing the viscosity of the magnetorheological fluid that is to be forced through the opening, and the counterforce becoming greater or smaller. The permanent magnet 12 surrounds the discharge channel and is arranged inside a spool 11 with the aid of which the magnetic flow can be decreased or diverted. Under the effect of the permanent magnet 12 the magnetorheological fluid in the discharge channel 6 is solid and becomes flowable as soon as the current flows through the spool 11. Since the control of the spool 11 is selectable and alterable, the viscosity of the fluid is alterable as well and the energy absorption is variable.

In lieu of the permanent magnet as shown, a simple arrangement of an electromagnet all around the discharge channel 6 is possible as well. The closure device 3 prevents an accidental flowing off of the medium which means that the electromagnet needs to be activated only in the event of an accident in order to increase the viscosity of the magnetorheological medium and thus the counterforce.

FIG. 4 shows a second embodiment of a steering column 9 that is equipped with two parts 14, that can be telescopically moved into each other and that are fixed in a normal position by means of a shear splint or the like. Part 15 is held by an element 7 that is permanently affixed to the vehicle body, and the second part 14 is connected to the steering wheel 8. Part 14 connected to the steering wheel 8 envelopes an impact energy absorbing element with a container 1 whose bottom abuts the second part 15 of the steering column 9 and to whose discharge channel 6 the steering wheel is attached in front. The compressible container part 4 is guided on its peripheral side by part 15 of the steering column 9 that is held by element 7 which is permanently affixed to the vehicle body.

When the compressible container part 4—whose wall is, for example, designed like a bellows—is compressed during an impact and the interior space is reduced, an initial excess pressure builds up that opens the closure device 3, thereby releasing the opening 2 on the discharge channel. The medium is forced out of the compressible container part 4 through the discharge channel 6. The displaced medium can be collected, if so desired, in a collection container. The container part 4 designed like a bellows can, for example, be made of metal or reinforced synthetics, with the rippling or, respectively, zigzag shape of the wall determining the bending and folding locations. The maximal compression of the container part 4 can be seen in FIG. 5.

In the event of an accident, the compressible container part 4 connected to the steering wheel 8 is bulged and compressed through the impact of the upper part of the body; the closure device 3 is thrown from the opening 2, and the medium is ejected. The mechanism 10 controls the flow of the medium through the discharge channel by means of a corresponding change of the viscosity in dependence of signals of the electronic system 16 which processes various measuring data and parameters.

The illustrations show cylindrical containers 1 that are, for example, designed like a bellows and that are compressible. Of course, other compressible containers 1 can be designed as well. The size of the compressible volume of the container 1; the cross section of the discharge channel 6 which codetermines the extent of the energy absorption; as well as the viscosity and the type of fluid are determined by the intended use of the element whose essential advantages lie, in any event, in the fact that it is one single piece, and in the volume reduction of the container 1 without any moving parts.

In the event that magnetorheological fluids are used, a condenser 17 housed in the steering wheel or, respectively, in the vicinity of the impact energy absorbing element, or a similar power source will be sufficient, meaning that the system will remain functional even in the event of a power failure of the motor vehicle. The length of the compression may amount to 100 mm in the embodiment shown in FIG. 5.

1-8. (canceled)

9. A steering column assembly, comprising:
an impact energy absorbing element including a deformable container containing a flowable medium;
a device for adjusting a flowability of the flowable medium;
wherein said container is connected with an opening and the medium is pushed out from the container and through said opening upon an impact; and
wherein said device for adjusting the flowability of the flowable medium is assigned to said opening.

10. The steering column assembly according to claim 9 configured as a steering column and impact absorption system in a motor vehicle.

11. The steering column according to claim 9, which comprises a closing device covering said opening and configured to open when a predetermined pressure in the flowable medium is exceeded.

12. The steering column according to claim 9, wherein said container is formed with a compressible container part and a substantially non-compressible discharge channel in which said opening is formed.

13. The steering column according to claim 12, wherein said device envelopes said discharge channel.

14. The steering column according to claim 12, wherein said compressible container part includes a deformable container wall.

15. The steering column according to claim 12, wherein said compressible container part is a bellows wall.

16. The steering column according to claim 9, wherein the flowable medium is a fluid configured to change a fluidity under an influence of a magnetic field.
